(19) United States
(12) Patent Application Publication
(10) Pub. No.: US 2015/0171508 A1
(43) Pub. Date: Jun. 18, 2015

(54) ANTENNA DEVICE, AND COMMUNICATION DEVICE WITH ANTENNA DEVICE

(71) Applicant: Samsung Electronics Co., Ltd., Suwon-si (KR)

(72) Inventors: Jong-Hyeok JEON, Seoul (KR); Hun-Cheol OH, Seoul (KR)

(21) Appl. No.: 14/570,453

(22) Filed: Dec. 15, 2014

(30) Foreign Application Priority Data
Dec. 16, 2013 (KR) 10-2013-0156346

(51) Int. Cl. H01Q 1/24; H01Q 5/307; H01Q 9/04

(52) U.S. Cl. CPC H01Q 1/243; H01Q 9/0407; H01Q 5/307

(57) ABSTRACT

An antenna device and a communication device with the antenna device are provided. The antenna device includes a first radiator located on a first layer, and a second radiator located on a second layer spatially separated from the first layer in the Z-axis direction, and electromagnetically coupled to the first radiator in the Z-axis direction. The first radiator and the second radiator are each electrically connected to a ground surface.

### CROSS-REFERENCE TO RELATED APPLICATION(S)

This application claims the benefit under 35 U.S.C. §119(a) of a Korean patent application filed on Dec. 16, 2013 in the Korean Intellectual Property Office and assigned Serial No. 10-2013-0156346, the entire disclosure of which is hereby incorporated by reference.

### TECHNICAL FIELD

The present disclosure relates to a communication device. More particularly, the present disclosure relates to a communication device with an antenna device.

### BACKGROUND

These days, electronic devices for communication (i.e., communication devices) are being developed to include various functions in compliance with a user's desire. For example, in addition to a basic function of telephoning with another user, a communication device can listen to a diversity of music using an MPEG Audio Layer 3 (MP3) sound source, enjoy web surfing using a wireless Internet network, download and use various programs using the wireless Internet network, and play back and view a high-quality video at high speed.

Also, a communication device is able to capture an image of a subject by having at least one high-pixel capturing element (i.e., a camera lens assembly). Particularly, the recent trend is to generalize a function of capturing a video as well as a still picture, specially, a three-dimensional picture.

To support the various functions such as the communication function, the communication device constructs and uses various antenna patterns operating at different frequency bands in one radiator, together. For example, the communication device can make common use of various bands of Code Division Multiple Access (CDMA), Global System for Mobile Communications (GSM), Long Term Evolution (LTE) and the like in one radiator. Also, the communication device is able to use communication functions of Wireless Fidelity (WiFi), Global Positioning System (GPS), Bluetooth and the like in one radiator.

The functions of such a radiator improve as the distance from a ground part of a substrate increases, and also improve as the ground area increases. However, the recent trend is to provide an electronic device that is increasingly lightweight, simple, and thinner in compliance with portability improvement and user preferences. Accordingly, technologies that improve the radiation performance of an antenna device without opposing this trend are being sought.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an antenna device, and a communication device with the antenna device.

Another aspect of the present disclosure is to provide an antenna device configured to implement sufficient radiation performance even when a sufficient mounting space is not secured, and a communication device with the antenna device.

Another aspect of the present disclosure is to provide an antenna device configured to implement sufficient radiation performance without design limit, and a communication device with the antenna device.

Another aspect of the present disclosure is to provide an antenna device configured to improve the radiation performance of a radiator in the same mounting condition, and secure a sufficient Radio Frequency (RF) bandwidth by increasing a volume of a radiator while increasing the freedom degree of patterning, and a communication device with the antenna device.

Another aspect of the present disclosure is to provide an antenna device configured to improve the radiation performance of a radiator using an existing surrounding structure even without a separate additional means, and a communication device with the antenna device.

According to an aspect of the present disclosure, a communication device including an antenna device is provided. The antenna device includes a first radiator located on a first layer, and a second radiator located on a second layer spatially separated from the first layer in the Z-axis direction, and electromagnetically coupled to the first radiator in the Z-axis direction, wherein the first radiator and the second radiator are each electrically connected to a ground surface.

According to another aspect of the present disclosure, an antenna device is provided. The antenna device includes a first radiator located on a first layer, and a second radiator located on a second layer spatially separated from the first layer in the Z-axis direction, and electromagnetically coupled to the first radiator in the Z-axis direction, wherein the first radiator and the second radiator are each electrically connected to a ground surface.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating a communication device with an antenna device according to an embodiment of the present disclosure;

FIG. 2 is a front perspective view illustrating an antenna device according to an embodiment of the present disclosure;

FIG. 3 is a rear perspective view illustrating an antenna device according to an embodiment of the present disclosure;

FIG. 4 is a mimetic diagram for computing a capacitance of a dielectric material between two metal plates according to an embodiment of the present disclosure;

FIGS. 5A, 5B, 5C, and 5D are cross sections illustrating the principal parts of a communication device and an installation state of an antenna device according to various embodiments of the present disclosure;

FIG. 6 is a graph illustrating a comparison between the radiation efficiency of an antenna device according to an embodiment of the present disclosure and the radiation efficiency of an antenna device of the related art; and

FIGS. 7A, 7B, and 7C are diagrams illustrating resonance bands in an antenna device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing various embodiments of the present disclosure, the term “communication device” is applicable to any electronic device of various forms having a communication function. The various embodiments of the present disclosure illustrate and describe a Planar Inverted-F Antenna (PIFA), but are not limited to this, and are applicable to other antenna devices.

In describing various embodiments of the present disclosure, a bar type electronic device including a touch screen as a display unit is illustrated and described, but this does not intend to limit the spirit and scope of the present disclosure. For instance, the electronic device can be any of various devices including an antenna device for communication, i.e., various devices such as a Personal Digital Assistant (PDA), a laptop computer, a mobile phone, a smart phone, a netbook, a Mobile Internet Device (MID), an Ultra Mobile PC (UMPC), a tablet PC, a navigator and the like.

According to various embodiments of the present disclosure, an antenna device and a communication device with the antenna device can be provided. The antenna device includes a first radiator located on a first layer, and a second radiator located on a second layer spatially separated from the first layer in the Z-axis direction, and electromagnetically coupled to the first radiator in the Z-axis direction. The first radiator and the second radiator are each electrically connected to a ground surface.

According to various embodiments, the second radiator located on the second layer can be separated in the X-axis direction and the Y-axis direction from the first radiator located on the first layer.

According to various embodiments, the second radiator can include one of a circuit substrate, a conductive tape, at least one part of a shield can, a metal bushing, a metal bracket, and the like.

According to various embodiments, the first layer can be arranged on a first surface of an antenna carrier, and the second layer can be arranged on a second surface of the antenna carrier.

According to various embodiments, one of the first radiator and the second radiator can be fixed, and the other one can be changed to implement a desired antenna radiation frequency.

According to various embodiments, the first radiator can be formed in at least one of a front case, a rear case, and a battery cover of the communication device.

According to various embodiments, spatial separation between the first radiator and the second radiator can generate at least a first resonance frequency.

According to various embodiments, separation of the X-axis direction and the Y-axis direction between the first radiator and the second radiator can generate at least a second resonance frequency.

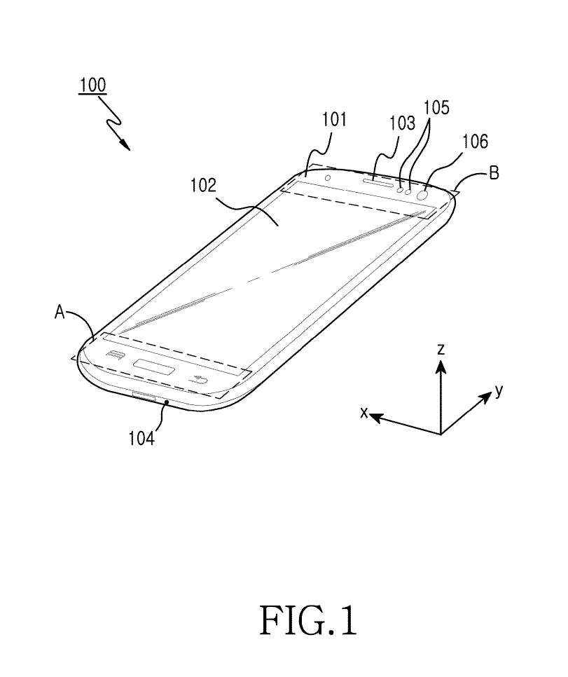

FIG. 1 is a perspective view illustrating a communication device with an antenna device according to various embodiments of the present disclosure.

Referring to FIG. 1, the communication device 100 can include a display module 102 installed on a front surface 101 of the communication device 100, a speaker device 103, installed at an upper side of the display module 102, for receiving and outputting a counterpart's voice, and a microphone device 104, installed at a lower side of the display module 102, for receiving and transmitting a voice to a counterpart, thereby being able to perform a basic communication function. According to an embodiment, the communication device 100 can include an interface connector arranged at one side of the microphone device 104 for wiredly performing a data transmission/reception function with an external device or for connecting to an external power source so as to charge a battery pack of the communication device 100.

According to various embodiments, electronic components for sensing can be arranged around the speaker device 103 of the communication device 100 and perform various functions of the communication device 100. One of these electronic components can be a camera device 106 for Video Telephony (VT) with a counterpart. Also, a sensor device 105 can be installed to variably activate the communication device 100 in accordance with the surrounding environment. The sensor device 105 can include an illumination sensor for detecting a surrounding illumination and automatically adjusting display brightness in accordance with a detected illumination value, a proximity sensor or infrared sensor for, when the communication device 100 is close to a user's head during a call, detecting the proximity and inactivating the display module 102, and the like.

According to various embodiments of the present disclosure, the communication device 100 can include an antenna device. The antenna device 10 may have a first radiator installed therein, and a second radiator spaced a certain distance apart from the first radiator 12 and coupled with the first radiator to make possible parasitic resonance. As illustrated in FIG. 1, it is desirable that the antenna device is arranged at a lower side (i.e., an ‘A’ region) of the communication device 100, but this does not intend to limit the spirit and scope of the present disclosure. For example, it does not matter that the antenna device is arranged in various regions of a component mounting space of the communication device 100, for example, in an upper region (i.e., a ‘B’ region) or side region of the communication device 100.

According to various embodiments of the present disclosure, the second radiator can be arranged in a position overlapping or not overlapping with the first radiator. According to an embodiment, the second radiator can be arranged in the Z-axis direction which is considered with respect to the first radiator. This can be greatly advantageous in space use compared to a radiator of the related art that is arranged only in the X-axis direction and the Y-axis direction. For example, by substantially extending the size of a radiator in a mounting space of the same size within the communication device 100 and increasing a spaced distance between the radiator and a ground part compared with a radiator of the related art, the communication device 100 can resultantly improve the radiation efficiency of the antenna device or extend its bandwidth.

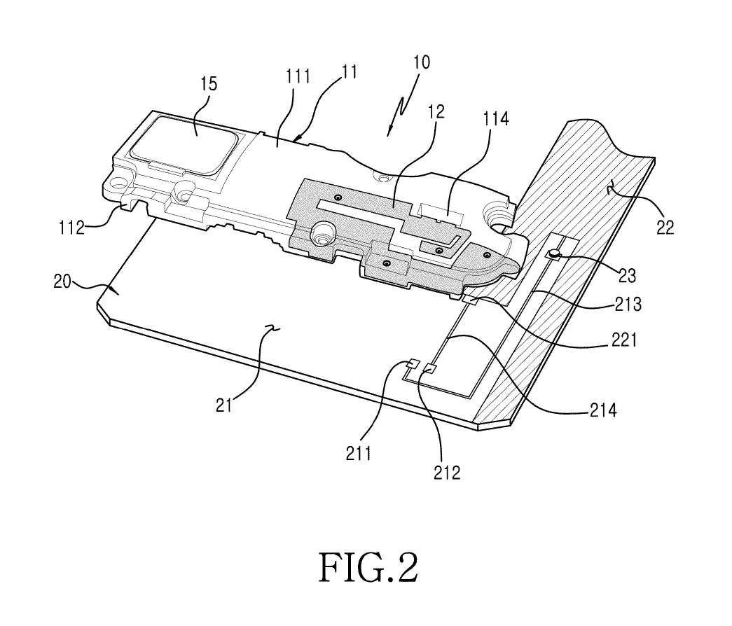

FIG. 2 is a front perspective view illustrating an antenna device according to an embodiment of the present disclosure.

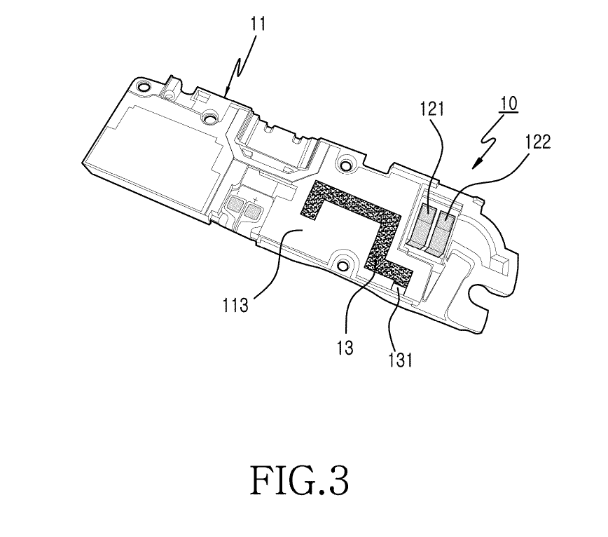

FIG. 3 is a rear perspective view illustrating an antenna device according to an embodiment of the present disclosure.

Referring to FIGS. 2 and 3, the antenna device 10 can include a substrate 20, an antenna carrier 11 mounted on the substrate 20, a first radiator 12 arranged on a top surface 111 of the antenna carrier 11, and a second radiator 13 arranged in a location different from the top surface 111 of the antenna carrier 11.

According to various embodiments, the substrate 20 can be a hard type substrate, or a soft type substrate such as a Flexible Printed Circuit Board (FPCB). According to an embodiment, the substrate 20 can include a non-ground area (i.e., non-conductive area) 21 and a ground area (i.e., conductive area) 22. The non-ground area 21 can arrange the antenna device 10 therein.

According to an embodiment, a feeding pad 211 for electrically connecting with the first radiator 12, a first ground pad 212, and a second ground pad 221 can be installed at regular intervals in the non-ground area 21 of the substrate 20. By means of a feeding line 213, the feeding pad 211 is electrically connected with a Radio Frequency (RF) connector 23 arranged in the non-ground area 21 of the substrate 20. By means of a ground line 214, the first ground pad 212 can be electrically connected with the ground area 22 of the substrate 20. According to an embodiment, the second ground pad 221 can be electrically connected with the ground area 22 of the substrate 20 as well.

According to various embodiments, the feeding pad 211 and the first ground pad 212 are electrically connected with the first radiator 12, and the second ground pad 221 can be electrically connected with the second radiator 13. According to various embodiments, the first ground pad 212 and the second ground pad 221 are arranged in spaced positions respectively, but may be concurrently grounded as one ground pad in accordance with mounting positions of the first radiator 12 and the second radiator 13.

According to various embodiments, the antenna carrier 11 can include a top surface 111, and a side surface 112 extended and formed to have a certain length along an edge of the top surface 111. According to an embodiment, the side surface 112 can play a role of giving a certain height to the antenna carrier 11, providing a spaced distance between the first radiator 12 and the ground area 22 of the substrate 20.

According to an embodiment, the first radiator 12 can be arranged on the top surface 111 of the antenna carrier 11. The first radiator 12 can be formed of conductive material. According to an embodiment, the first radiator 12 can be formed by insert molding to the top surface 111 of the antenna carrier 11 of synthetic resin material. According to an embodiment, the first radiator 12 may be arranged in such a way that it is attached to the top surface 111 of the antenna carrier 11. According to an embodiment, the first radiator 12 can use at least one of a metal plate in which a radiation pattern is formed, and a flexible printed circuit including a radiation pattern.

According to various embodiments, the second radiator 13 can be arranged on an inner surface of the antenna carrier 11. According to an embodiment, the second radiator 13 can be arranged on an outer surface of the antenna carrier 11. According to an embodiment, the first radiator 12 may be arranged on the inner surface of the antenna carrier 11, and the second radiator 13 may be arranged on the side surface 112 of the antenna carrier 11.

According to an embodiment, the antenna carrier 11 can mount at least one electronic component in addition to the first radiator 12 and the second radiator 13, together. According to an embodiment, the electronic component can include at least one of a speaker module 15, a microphone module, a vibrator, various kinds of sensor modules, and the like.

According to an embodiment, a pin inlet hole 114 is provided in the top surface 111 of the antenna carrier 11 to pass up to a rear surface 113 of the antenna carrier 11, so a feeding pin 121 of the first radiator 12 and a first ground pin 122 thereof can be arranged such that they can be exposed to the rear surface 113 of the antenna carrier 11 after passing through the pin inlet hole 114. The rear surface 113 of the antenna carrier 11 is mounted on a top surface of the substrate 20 in such a way that it makes contact with the top surface of the substrate 20. Accordingly, the feeding pin 121 of the first radiator 12 and the first ground pin 122 thereof can easily make contact with the feeding pad 211 of the substrate 20 and the first ground pad 212 thereof, respectively. But, this does not intend to limit the spirit and scope of the present disclosure, and the feeding pin 121 of the first radiator 12 and the first ground pin 122 thereof may be installed in such a way that they bypass the side surface 112 of the antenna carrier 11 and extend to the rear surface 113 of the antenna carrier 11.

According to various embodiments, the first radiator 12 is attached in a metal plate type to the top surface 111 of the antenna carrier 11 of a certain height which is arranged to avoid the substrate 20 or a top portion of the substrate 20, but this does not intend to limit the spirit and scope of the present disclosure. For example, if a space of the substrate 20 is allowed, it does not matter that the first radiator 12 is formed directly on the substrate 20 as a pattern. Also, the first radiator 12 may be a plurality of radiation patterns of a certain shape which are formed on a PCB of a side spaced apart from the substrate 20.

The second radiator 13 is arranged on the rear surface 113 facing the top surface 111 of the antenna carrier 11. According to an embodiment, the second radiator 13 can be formed by insert molding to the rear surface 113 of the antenna carrier 11 of synthetic resin material as well. According to an embodiment, the second radiator 13 may be arranged in such a way that it is attached to the rear surface 113 of the antenna carrier 11. According to an embodiment, the second radiator 13 can use at least one of a metal plate in which a radiation pattern is formed, and a flexible printed circuit including a radiation pattern. According to an embodiment, the rear surface 113 of the antenna carrier 11 can be formed integrally with the antenna carrier 11 or be a separate supplementary accessory of the antenna carrier 11.

According to an embodiment, the second radiator 13 can have a construction arranged to expose a second ground pin 131 at its end and electrically connected with the second ground pad 221 of the substrate 20. As illustrated, the feeding pin 121, the first ground pin 122, and the second ground pin 131 are arranged on the rear surface 113 of the antenna carrier 11 such that they are all externally exposed. Accordingly, by only an assembly process of mounting the antenna carrier 11 on the substrate 20, the feeding pin 121, first ground pin 122, and second ground pin 131 are electrically connected to the feeding pad 211, first ground pad 212, and second ground pad 221 of the substrate 20, respectively.

According to an embodiment, the second radiator 13 is arranged on the rear surface 113 of the antenna carrier 11, but it does not matter that the second radiator 13 is arranged in any position of the communication device 100 having a certain spaced distance at which the first radiator 12 and the second radiator 13 are coupled with each other. For instance, the second radiator 13 may be formed as a pattern on the substrate 20 which is separated to be coupled with the first radiator 12.

According to an embodiment, the second radiator 13 can be arranged in a position at least partially overlapping with the first radiator 12. According to an embodiment, the second radiator 13 may be arranged in a position capable of being coupled with the first radiator 12, without overlapping with the first radiator 12. According to an embodiment, the second radiator 13 can be at least one of a separately prepared metal plate having a certain width, a flexible printed circuit having a metal pattern, a conductive tape, and the like. According to an embodiment, the second radiator 13 is not separately prepared, and may be at least one of the speaker module 15 of metal material that is an accessory structure of the communication device 100, a bracket, a bushing, a vibrator, a shield can, and the like. According to an embodiment, the second radiator 13 can be an FPCB of a touch pad that is arranged in a position capable of being coupled with the first radiator 12. In this case, the first radiator 12 and the second radiator 13 can use a common ground means such as a Liquid Crystal Display (LCD) supporting bracket of metal material. According to an embodiment, a plurality of second radiators 13 may be constructed.

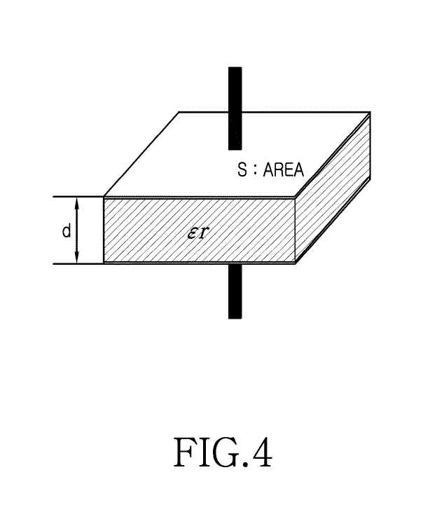

FIG. 4 is a mimetic diagram for computing a capacitance of dielectric material between two metal plates according to an embodiment of the present disclosure.

Referring to FIG. 4, a dielectric constant of a dielectric material (e.g., air, a case frame, and the like) between two metal plates is used, and an area (S) of the metal plate by a capacitance C value can be calculated as in Equation 1 below.

$$C = ɛ \frac{S}{d} \qquad Equation 1$$

In Equation 1, ‘C’ is the capacitance between two metal plates, ‘S’ is an area of the metal plate, ‘d’ is a spaced distance between the metal plates, and the ‘∈’ is ∈r×∈0 (∈r: relative permittivity, and ∈0=8.854×10⁻¹²). That is, a desired C value can be calculated considering a relationship in which the capacitance C value is inversely proportional to the spaced distance (d) and is proportional to the area (S) of the metal plate. Accordingly, if the capacitance C value considering an impedance value at a desired frequency band is given, the area (S) of the two metal plates considering the spaced distance will be able to be calculated.

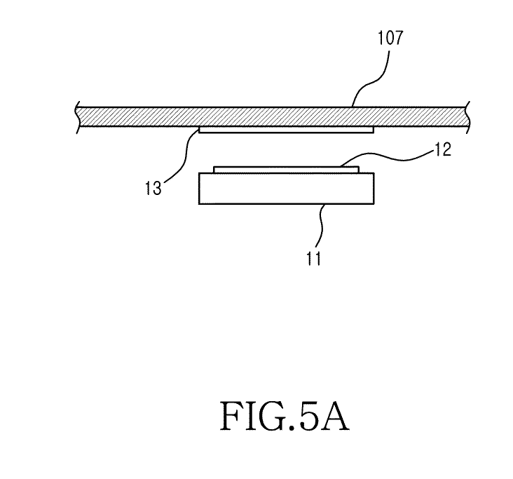

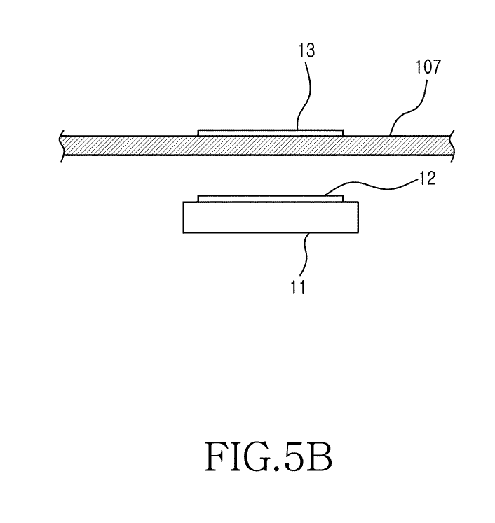

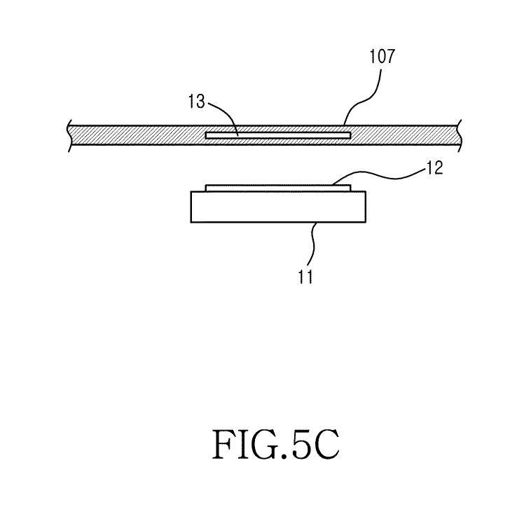

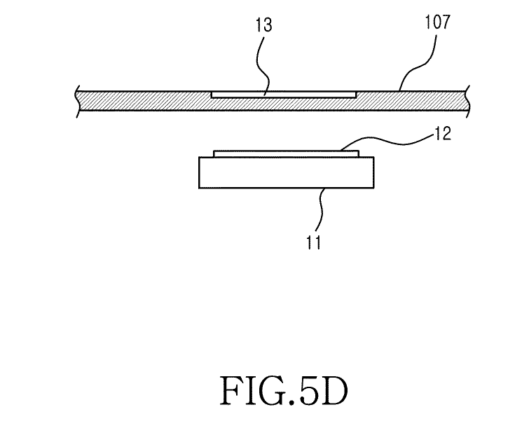

FIGS. 5A, 5B, 5C and 5D are cross sections illustrating the principal parts of a communication device and an installation state of an antenna device according to various embodiments of the present disclosure.

As illustrated in FIGS. 5A and 5B, the second radiator 13 can be arranged in such a way that it is attached to an inner surface or outer surface of a case frame 107 of the communication device. According to an embodiment, the second radiator 13 can be arranged in a position capable of being coupled with the first radiator 12. According to an embodiment, if coupling with the first radiator 12 is possible, the second radiator 13 may be arranged in such a way that it overlaps, partially overlaps, or does not overlap with the first radiator 12 in the Z-axis direction. According to an embodiment, the second radiator 13 can be a metal plate, a flexible printed circuit in which a metal pattern is formed, a metal tape, and a metal spray layer having a certain area and a certain thickness and coated on the inner surface of the case frame 107.

According to an embodiment, if the second radiator 13 is arranged in such a way that it is exposed to the outer surface of the case frame 107 of the communication device, the second radiator 13 can operate as a parasitic resonator and concurrently play a role of a metal decoration contributing to an appearance of the communication device.

According to an embodiment, though not illustrated, the second radiator 13 can have a construction electrically connected with a ground part electrically connected with the first radiator 12. According to an embodiment, the second radiator 13 can be electrically connected with the ground part by means of a metallic bushing, a metal tape, a C clip, a hairline cable, and the like. According to an embodiment, the second radiator 13 may be electrically connected with a ground part different from the ground part electrically connected with the first radiator 12.

As illustrated in FIGS. 5C and 5D, if the case frame 107 of the communication device is formed of synthetic resin material, the second radiator 13 may be formed by insert molding to the case frame 107 at the time of injection of the case frame 107, together. According to an embodiment, the second radiator 13 may be arranged in such a way that it is fully buried in the case frame 107, or may be arranged in such a way that it is partially exposed to the outer surface or inner surface of the case frame 107.

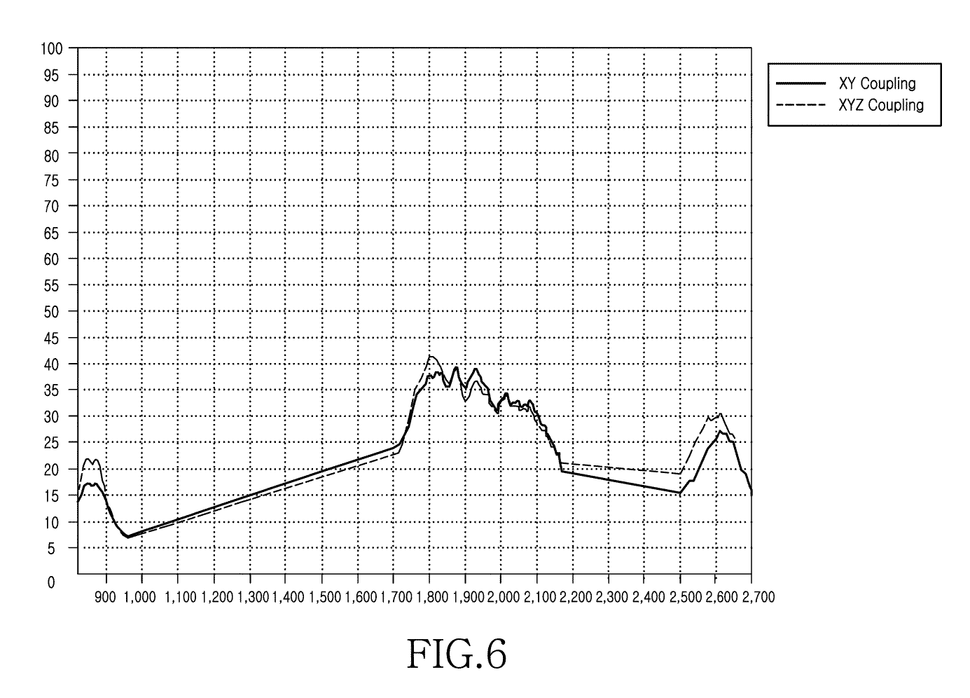

FIG. 6 is a graph illustrating a comparison between the radiation efficiency of an antenna device according to an embodiment of the present disclosure and the radiation efficiency of an antenna device of the related art.

As illustrated in FIG. 6, it can be appreciated that the antenna device having a three-dimensional arrangement structure of the X-axis, Y-axis, and Z-axis directions in accordance with various embodiments of the present disclosure exhibits excellent radiation efficiency compared to the antenna device of the related art having a planar arrangement structure of the X-axis and Y-axis directions. For example, it can be appreciated that the antenna device of the present disclosure increases the radiation efficiency by approximately 5% at a low band of 800 Mega Hertz (MHz) to 900 MHz, and increases the radiation efficiency of approximately 3% to 4% at high bands of 1750 MHz to 1900 MHz and 2500 MHz to 2700 MHz.

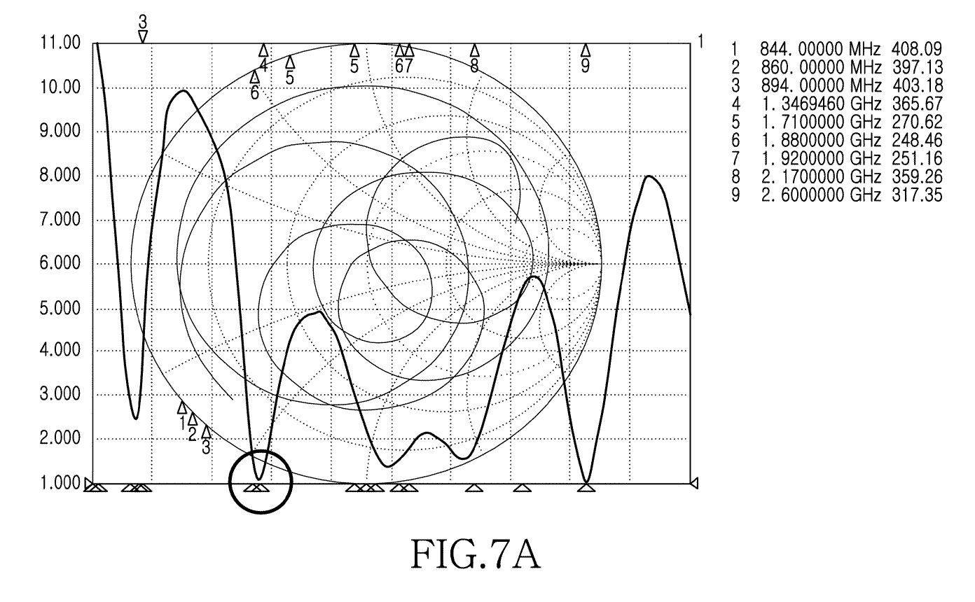

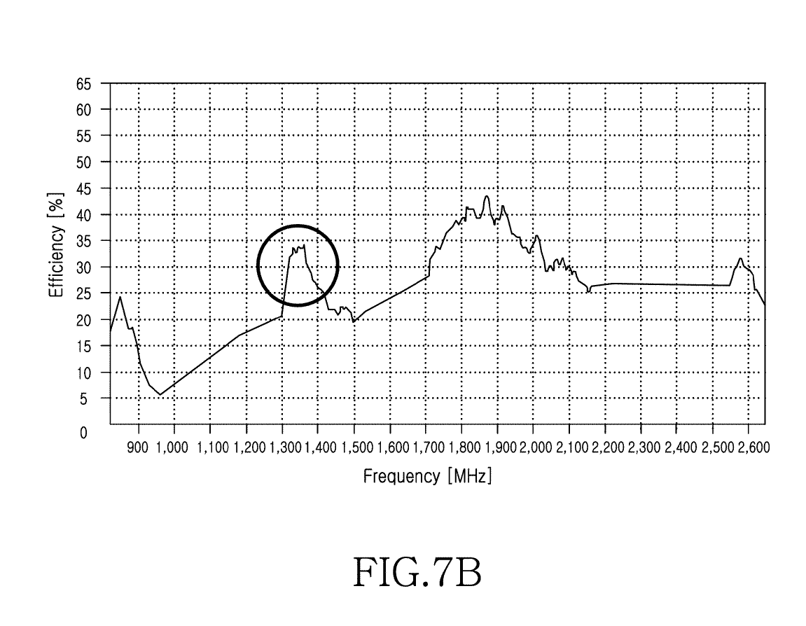

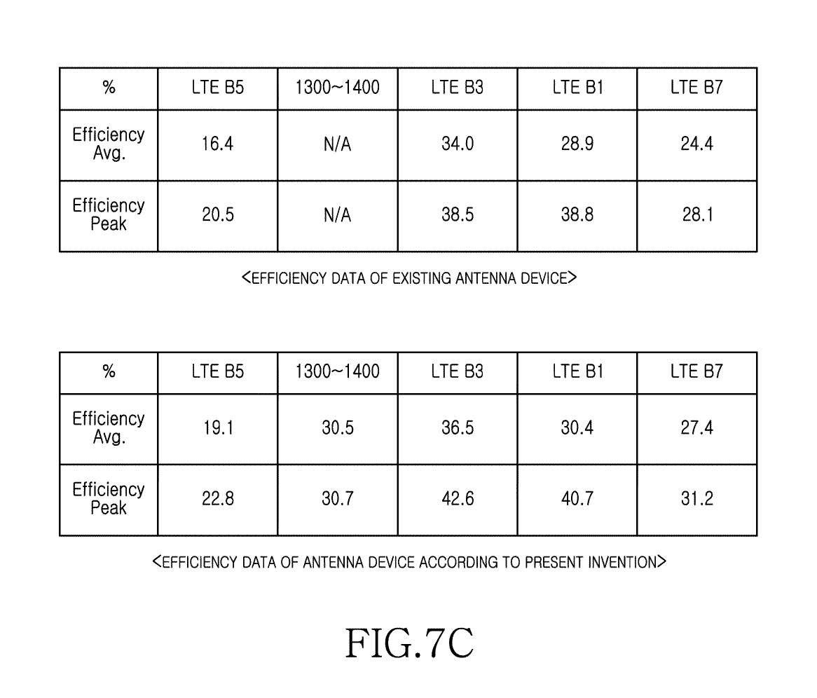

FIGS. 7A to 7C are diagrams illustrating resonance bands in an antenna device according to various embodiments of the present disclosure.

FIG. 7A is a Voltage Standing Wave Ratio (VSWR) graph showing an additionally created resonance band of an antenna device according to an embodiment of the present disclosure. FIGS. 7B and 7C are a radiation efficiency data graph showing an additionally created resonance band of an antenna device and a table of comparison at each band according to an embodiment of the present disclosure.

As illustrated, it can be appreciated that the antenna device of the related art generates no additional resonance band, but the antenna device according to an embodiment of the present disclosure newly generates additional resonance at a band of 1300 MHz to 1400 MHz.

According to various embodiments, the antenna device of the present disclosure can extend an existing bandwidth in consideration of an arrangement position and area (i.e., size) of the second radiator 13 coupled with the first radiator 12, or can newly generate an additional resonance band.

According to various embodiments of the present disclosure, the antenna device of the present disclosure can prevent the performance degradation of the antenna device caused by the deficiency of a mounting space of a communication device, and can improve the radiation characteristic and radiation efficiency of the antenna device without space extension and design limit.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A communication device comprising an antenna device,
wherein the antenna device comprises:
a first radiator located on a first layer; and
a second radiator located on a second layer spatially separated from the first layer in the Z-axis direction, and electromagnetically coupled to the first radiator in the Z-axis direction,
wherein the first radiator and the second radiator are each electrically connected to a ground surface.

2. The communication device of claim 1, wherein the second radiator located on the second layer is separated in the X-axis direction and the Y-axis direction from the first radiator located on the first layer.

3. The communication device of claim 1, wherein the second radiator comprises at least one of a circuit substrate, a conductive tape, at least one part of a shield can, a metal bushing, and a metal bracket.

4. The communication device of claim 1, wherein the first layer is arranged on a first surface of an antenna carrier, and the second layer is arranged on a second surface of the antenna carrier.

5. The communication device of claim 1, wherein the one of the first radiator and the second radiator is fixed, and the other of the first radiator and the second radiator is changeable to implement a desired antenna radiation frequency.

6. The communication device of claim 5, wherein the first radiator is formed in at least one of a front case, a rear case, and a battery cover of the communication device.

7. The communication device of claim 5, wherein a spatial separation in the Z-axis direction between the first radiator and the second radiator generates at least a first resonance frequency.

8. The communication device of claim 7, wherein a spatial separation in the X-axis direction and the Y-axis direction between the first radiator and the second radiator generates at least a second resonance frequency.

9. An antenna device comprising:
a first radiator located on a first layer; and
a second radiator located on a second layer spatially separated from the first layer in the Z-axis direction, and electromagnetically coupled to the first radiator in the Z-axis direction,
wherein the first radiator and the second radiator are each electrically connected to a ground surface.

10. The antenna device of claim 9, wherein the second radiator located on the second layer is separated in the X-axis direction and the Y-axis direction from the first radiator located on the first layer.

11. The antenna device of claim 9, wherein the second radiator comprises at least one of a circuit substrate, a conductive tape, at least one part of a shield can, a metal bushing, and a metal bracket.

12. The antenna device of claim 9, wherein the first layer is arranged on a first surface of an antenna carrier, and the second layer is arranged on a second surface of the antenna carrier.

13. The antenna device of claim 9, wherein the one of the first radiator and the second radiator is fixed, and the other of the first radiator and the second radiator is changeable to implement a desired antenna radiation frequency.

14. The antenna device of claim 13, wherein the first radiator is formed in at least one of a front case, a rear case, and a battery cover of the communication device.

15. The antenna device of claim 13, wherein a spatial separation in the Z-axis direction between the first radiator and the second radiator generates at least a first resonance frequency.

16. The antenna device of claim 15, wherein a spatial separation in the X-axis direction and the Y-axis direction between the first radiator and the second radiator generates at least a second resonance frequency.
